(19) United States
(12) Patent Application Publication
(10) Pub. No.: US 2013/0219146 A1
(43) Pub. Date: Aug. 22, 2013

(54) METHOD, DEVICE AND SYSTEM FOR A CONFIGURABLE ADDRESS SPACE FOR NON-VOLATILE MEMORY

(71) Applicant: Emanuele Confalonieri, Lesmo (Milano) (IT)

(72) Inventor: Emanuele Confalonieri, Lesmo (Milano) (IT)

(73) Assignee: Micron Technology, Inc., Boise, ID (US)

(21) Appl. No.: 13/398,642

(22) Filed: Feb. 16, 2012

(51) Int. Cl. G06F 12/06

(52) U.S. Cl. 711/202; 711/E12.084

(57) ABSTRACT

Example embodiments described herein may relate to memory devices, and may relate more particularly to configurable address space for non-volatile memory devices.

### BACKGROUND

Subject matter disclosed herein may relate to memory devices, and may relate, more particularly, to a configurable address space for non-volatile memory devices.

Non-volatile memory devices may be found in a wide range of electronic devices. For example, non-volatile memory devices may be used in computers, digital cameras, cellular telephones, personal digital assistants, etc. Non-volatile memory devices may also be incorporated into solid state storage drives for use with computer systems and/or other electronic devices, for example. As an additional example, non-volatile memory devices may also comprise memory cards compatible or compliant with Multi Media Card specification version 4.4, also known as JEDEC Embedded MMC (eMMC) Standard MMCA 4.4 (JESD84-A44) (March 2009; available from MMCA).

### BRIEF DESCRIPTION OF THE DRAWINGS

Claimed subject matter is particularly pointed out and/or distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram illustrating an example embodiment of a computing platform.

FIG. 2 is a schematic block diagram depicting an example embodiment of a non-volatile memory device.

FIG. 3 is a block diagram depicting example logical and physical address spaces for an example embodiment of a non-volatile memory device.

FIG. 4 is a block diagram depicting example logical and physical address spaces for an example embodiment of a non-volatile memory device.

FIG. 5 is a block diagram depicting example logical and physical address spaces for an example embodiment of a non-volatile memory device.

FIG. 6 is a block diagram depicting example logical and physical address spaces for an example embodiment of a non-volatile memory device.

FIG. 7 is a schematic block diagram illustrating an example embodiment of a computing platform.

Reference is made in the following detailed description to the accompanying drawings, which form a part hereof, wherein like numerals may designate like parts throughout to indicate corresponding and/or analogous components. It will be appreciated that for simplicity and/or clarity of illustration, components illustrated in the figures have not necessarily been drawn to scale. For example, the dimensions of some may be exaggerated relative to others. Further, it is to be understood that other embodiments may be utilized. Furthermore, structural and/or logical changes may be made without departing from the scope of claimed subject matter. It should also be noted that directions, references and/or other position indications, for example, such as, up, down, top, bottom, and so on, may be used to facilitate discussion of the drawings and are not intended to restrict the application of claimed subject matter. Therefore, the following detailed description is not to be taken to limit the scope of claimed subject matter and/or its equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses and/or systems that would be known by one of ordinary skill have not been described in detail so as not to obscure claimed subject matter.

As mentioned above, non-volatile memory devices may be found in a wide range of electronic devices. For example, non-volatile memory devices may be used in computers, digital cameras, cellular telephones, personal digital assistants, etc. Non-volatile memory devices may also be incorporated into solid state storage drives for use with computer systems and/or other electronic devices, for example. Some embodiments of non-volatile memory devices may comprise memory cards, for example, although the scope of claimed subject matter is not limited in this respect. For example, in an embodiment, a memory device may comprise a memory card compatible and/or compliant with MultiMediaCard specification version 4.4, previously referenced. Additionally, non-volatile memory devices may comprise one or more arrays of non-volatile memory cells. Likewise, different arrays of non-volatile memory cells in some example memory devices may comprise different memory technologies, in some situations.

In this context, the term different memory technologies is intended to refer to memory technology in which techniques to read and/or write to a memory cell of an array employ different physical processes. As a simple example, NAND flash memory (referred to as NAND) technology is considered in this context to be a different memory technology than Phase Change Memory (referred to as PCM) technology. Likewise, the term hybrid in this context refers to a situation in which different memory technologies are employed together in a particular system, device, component, product, etc. Two or more arrays of non-volatile memory cells implemented using two or more different memory technologies may be implemented on two or more integrated circuit die in some circumstances, for example, although claimed subject matter is not limited in this respect.

For some example embodiments, non-volatile memory devices that incorporate non-volatile memory cell arrays comprising different memory technologies may be referred to as “hybrid” memory devices. Also in example embodiments, managed hybrid memory devices may have a configuration according to desired system goals. For example, storage and/or other performance criteria may influence choices with respect to which types of technologies to employ. In some example embodiments, memory configurations may be adjusted after device manufacture by writing one or more signals indicative of an appropriate value to a configuration register.

Example hybrid memory architectures incorporating two or more memory cell technologies, perhaps implemented on two or more respective integrated circuit die for some embodiments, may allow system performance to be enhanced in connection with memory operations, for example. In some example embodiments of a non-volatile memory device, one or more non-volatile cell arrays may comprise one or more single-level-cell arrays. As used herein, “single-level-cell” (SLC) refers to a non-volatile memory cell that stores a single binary digital signal, also referred to as a bit, of information in accordance with a physical state of the cell. For example, accumulated charge may be measured at a floating gate of a memory cell to indicate the physical state of the cell. Voltage values detected within certain approximate ranges may indicate a zero state or a one state, as one example. Of course, this is merely an illustrative example and claimed subject matter is not limited in scope to this example. Also in some example embodiments of a non-volatile memory device, one or more non-volatile cell arrays may comprise one or more multi-level-cell arrays. As used herein, “multi-level-cell” (MLC) refers to a non-volatile memory cell capable of storing more than a single binary digital single, also referred to as a bit, of information in accordance with a physical state of the cell. For example, along the lines of the previously described SLC, an MLC may be capable of storing accumulated charge; however, voltage values detected within certain approximate ranges may indicate one of four possible states, as one example.

Nonetheless, in some embodiments, a multi-level-cell may be employed to store a single bit of information. That is, for one or more example embodiments, one or more areas of an MLC array may operate as one or more SLC areas. Also for an embodiment, a multi-level-cell employed to store a single bit of information may have performance characteristics that may improve relative performance characteristics for a multi-level-cell employed to store more than one bit of information. For example, resolving one of two states (e.g., SLC) rather than one of four states (e.g., MLC) may present fewer technical issues. On the other hand, MLC areas of an MLC array have a potential advantage of relatively greater bit storage density as compared with an SLC area.

In an example embodiment, an MLC non-volatile memory array may be partitioned into one or more areas so that different areas of an MLC array may have different configurations. For example, one or more MLC areas may have a configuration as an SLC area, while other MLC areas may have an MLC configuration. Through combinations of SLC or MLC areas, an array of MLC non-volatile memory cells may be employed in various ways.

For example, one or more SLC areas may have a configuration for use as storage areas to retain states indicative of executable instructions related to system boot-up, operating system executable instructions, and/or security-related instructions, to name but a few examples. For example, areas storing information of these types may be more frequently accessed, resulting potentially in improved overall system performance. Additionally, for an embodiment, areas of an MLC array not having an SLC configuration may be utilized for other storage, such as for information less frequent accessed, for example. In this manner, for example, relatively frequently accessed information may be stored in relatively higher performance SLC areas, and other information may be stored in higher storage density MLC areas. By adjusting relative sizes of SLC and MLC areas, various system utilization goals may be better achieved, for example. In some circumstances, configuration of an MLC array into MLC and SLC areas may be referred to as a “flex-solution” or “managed flex system.”

Non-volatile memory devices may comprise a controller to manage operations to access one or more arrays of non-volatile memory cells. In an embodiment, a controller may perform logical-to-physical address mapping operations for memory access commands directed to particular memory cells of particular memory arrays, for example. Examples of logical address mapping are described below, although claimed subject matter is not limited in scope to specific examples disclosed herein. In some example memory devices, such as a hybrid device, two or more arrays of non-volatile memory cells may be implemented using two or more different memory technologies. Two or more arrays of non-volatile memory cells implemented using two or more different technologies may be implemented on two or more integrated circuit die in some circumstances, for example, although claimed subject matter is not limited in this respect.

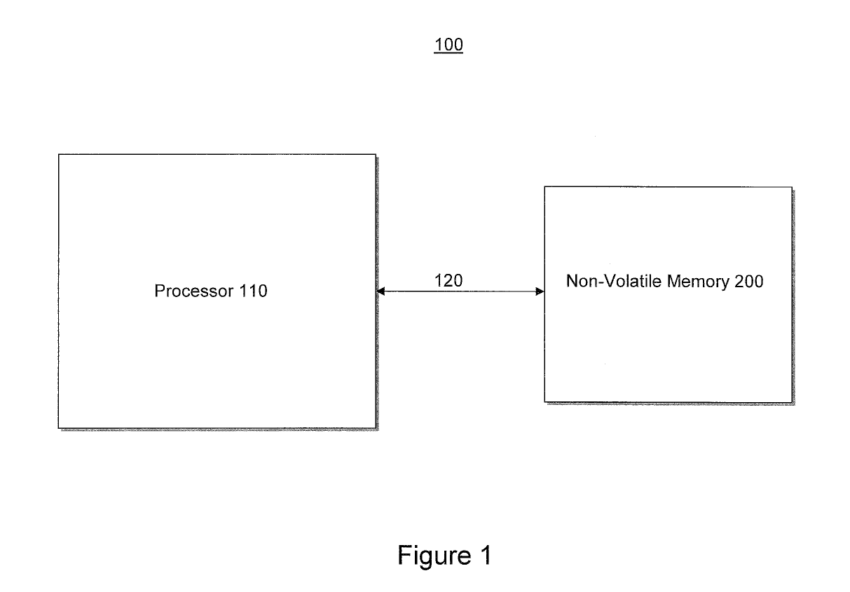

FIG. 1 is a block diagram of an example embodiment of a computing platform 100, comprising a processor 110 and a non-volatile memory 200 communicating via bus 120. For an example embodiment, non-volatile memory device 200 may comprise a hybrid memory device, such as one employing phase-change memory (PCM) technology and NAND memory technology, although claimed subject matter is not limited in scope in this respect. Of course, in alternate embodiments, memory 200 may comprise other memory technologies beyond PCM or NAND. These two are provided merely as illustrative examples.

In this context, PCM technology comprises memory technology in which a physical state of a cell may be changed by application of a sufficient amount of heat. A non-volatile memory device employing PCM technology may comprise one or more SLC arrays in this example. A non-volatile memory device employing NAND technology may comprise one or more MLC arrays in this example. Of course, again, claimed subject matter is not intended to be limited in this manner.

Memory 200 for an example embodiment may be coupled to processor 110 by way of an interconnect, such as bus 120. In an example embodiment, bus 120 may comprise a parallel bus, although claimed subject matter is not limited in scope in this respect. Processor 110 may fetch states indicative of executable instructions stored in memory 200 via bus 120, and processor 110 may execute the fetched instructions. States may also be written to and/or read from memory 200 by processor 110 via bus 120. A controller within non-volatile memory 200 executing firmware instructions stored within non-volatile memory 200 may be utilized to implement memory read and/or write accesses, in accordance with one or more command codes received from processor 110, for example.

For an example embodiment, a configuration of computing platform 100 may comprise an execute-in-place (XiP) implementation, wherein processor 110 may fetch instructions from “long-term memory,” such as memory comprising non-volatile memory device 200, for example. In contrast, an example of a non-XiP implementation may comprise a processor fetching stored instructions from a volatile memory device, such as a dynamic random access memory (DRAM).

As used herein, “computing platform” refers to a system and/or a device that includes an ability to store and process electrical signals. Typically, a computing system may include a processor, a memory and a bus coupling the processor and memory. For example, signals to be processed may be stored in memory as states ahead of processing. Likewise, results of processing may be stored in memory as states after processing. A computing platform, in this context, may comprise hardware, software, firmware or any combination thereof (excluding software per se).

Computing platform 100, as depicted in FIG. 1, is merely one such example, and claimed subject matter is not limited in scope to this illustrative example. For one or more embodiments, for example, a computing platform may comprise any of a wide range of digital electronic devices, including, but not limited to, personal desktop and/or notebook computers, high-definition televisions, digital versatile disc (DVD) players and/or recorders, game consoles, satellite television receivers, cellular telephones, personal digital assistants, mobile audio and/or video playback and/or recording devices, etc., including any combinations thereof. Further, unless specifically stated otherwise, a process as described herein, with reference to flow diagrams and/or otherwise, may also be executed and/or controlled, in whole or in part, by a computing platform. For example embodiments described herein, computing platform 100 may comprise a cellular telephone, although, again, the scope of claimed subject matter is not so limited.

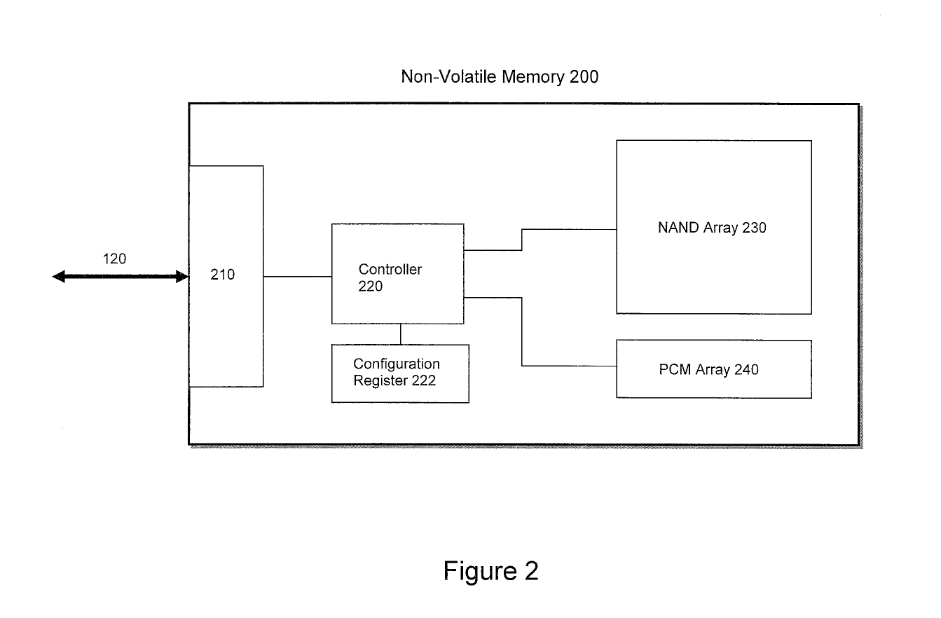

FIG. 2 is a schematic block diagram depicting an example embodiment of non-volatile memory device 200 including an interconnect interface 210 to receive one or more signals representing commands and/or other signal information from processor 110, for example. In an embodiment, signals indicative of executable instructions may be transmitted by processor 110 to memory device 200. Executable instructions may also be retrieved by processor 110 from memory device 200 and may be transmitted from memory device 200 to processor 110 via interconnect 120, in an embodiment. Memory device 200 may also transmit and/or receive signals via interconnect interface 210 representative of stored memory address locations and/or stored information content, for example. For one or more embodiments, a controller 220 may receive one or more signals indicative of commands and/or signal other information from processor 110 via interconnect 120 and interface 210, and may generate one or more internal control signals to perform any of a number of operations, including read and/or write operations, by which processor 110 may access PCM array 240 and/or NAND array 230, for example.

As used herein, “controller” refers to any circuitry, including hardware logic, for example, involved in management and/or execution of command sequences that relate to memory operations to be performed by a non-volatile memory device. “Controller” further may refer to an ability to execute firmware instructions as part of management and/or execution of command sequences, in an embodiment. In an embodiment, “controller” may comprise circuitry, including hardware logic, for example, involved in logical-to-physical memory address mapping operations, examples of which are described below. Of course, claimed subject matter is not limited in scope to specific examples described herein. Non-volatile memory device 200 may also comprise a configuration register 222 that may store states indicative of one or more logical memory address map configurations, in an example embodiment.

Also as used herein, the term “device” as it relates to non-volatile memory may refer to an array of memory cells or may refer to a component having one or more arrays of memory cells in addition to other circuitry for performing memory operations, such as, for example, a controller. Thus, for example, non-volatile memory 200, NAND array 230, and PCM array 240 comprise examples of devices. Of course, these are merely examples, and claimed subject matter is not limited in scope in this respect.

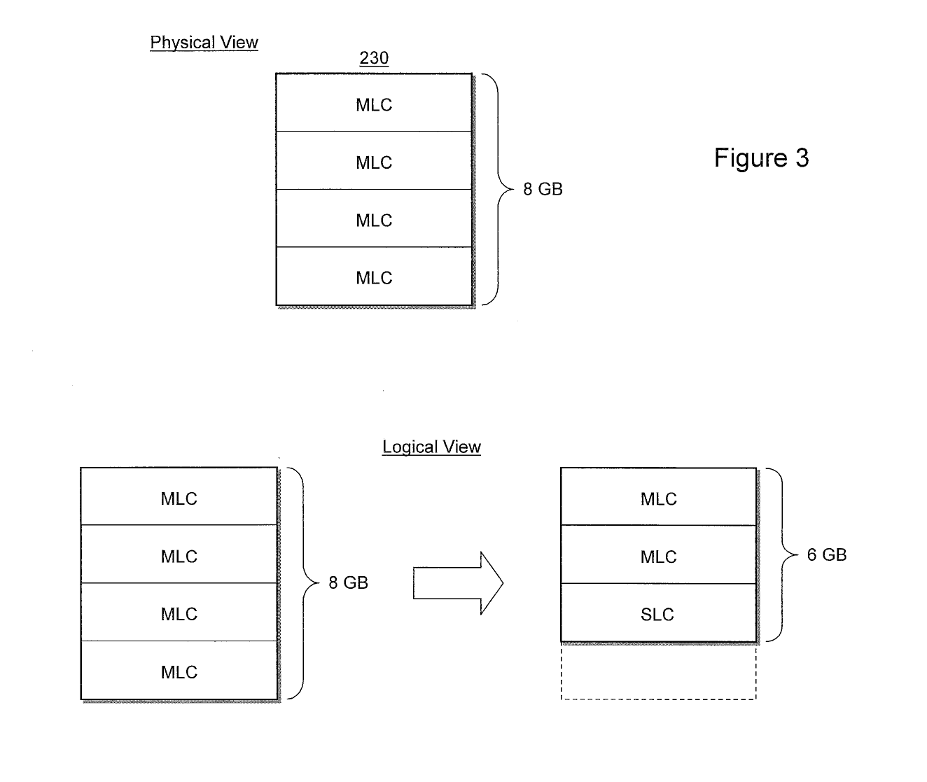

FIG. 3 is a block diagram depicting example logical and physical address space configurations for an example embodiment of non-volatile memory device 200. As shown in FIG. 2, memory 200, for an example embodiment, may comprise NAND array 230. For an example embodiment, NAND array 230 may comprise an array of multi-level-cells (MLC). NAND array 230 may, for example, comprise 8 GBytes of storage area. NAND array 230 may, for example, be implemented as 4 GB individual cells, where an individual cell may have a capability to store two binary digital signals, referred to here as bits.

NAND array 230, continuing with this example, may be partitioned into four areas of 2 GB storage, as depicted in FIG. 3, although claimed subject matter is not limited in this respect. An initial logical view of an address space for NAND array 230 may comprise an address space of 8 GB, which also represents the physical storage area of NAND array 230.

As previously mentioned, in an example MLC array, a managed flex system may comprise an MLC array with an area having an SLC configuration and an area having an MLC configuration. For NAND array 230, in an example, two MLC areas may be combined and have a configuration to form an SLC area capable of storing 2 GB. As depicted in FIG. 3, two MLC areas of NAND array 230 may make up another 4 GB of logical memory space. Thus, in an embodiment, a total of 6 GB of memory space may be available for a logical address space for non-volatile memory device 200. For this example of FIG. 3, PCM array 240 is not utilized to first illustrate a managed flex system rather than a managed hybrid system.

In an example embodiment, logical memory space mapped to an SLC area formed by combining two areas of NAND array 230 may be referred to as system memory space. As used herein, “system memory space” refers to logical memory space that may be utilized to store one or more states indicative of information that may be relatively frequently accessed. For example, system memory space may be utilized to store states indicative of operating system executable instructions. For another example, system memory space may be utilized to store states indicative of executable instructions to be accessed in response to a system boot-up. Of course, these are merely examples and claimed subject matter is not limited in scope in this respect. In an embodiment, system memory space may be mapped to a relatively higher performance SLC area, as suggested previously. By storing states indicative of information likely to be relatively frequently access, overall system performance may be enhanced.

Next, examples of managed hybrid memory systems shall be illustrated. Although examples described herein or depicted in the figures discuss specific configurations of memory, including examples of device densities, example memory technologies, example total storage area, example area sizes, and so forth, claimed subject matter are not intended to be limited to these specific examples. Other embodiments may be implemented using other memory technologies, other sizes of memory devices, and/or other memory device densities, to list several examples.

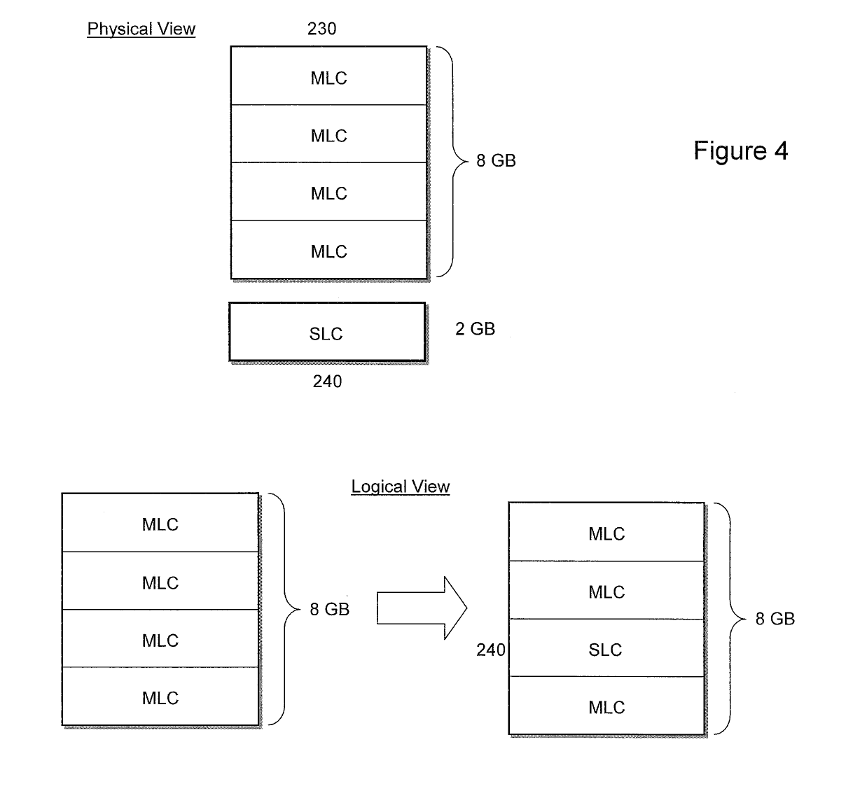

FIG. 4 is a block diagram depicting example logical and physical address spaces for an example embodiment. As with the example of FIG. 3, initially a view of a logical address space for NAND array 230 may comprise an address space of 8 GB, which also represents physical storage area. However, for the example depicted in FIG. 4, PCM array 240 may be utilized as part of a physical memory space. An SLC area may comprise 2 GB, for example. An SLC area mapped to PCM array 240 may replace a 2 GB area of NAND array 230. In an example embodiment, three remaining MLC areas may be combined with one SLC area to form a logical address space of 8 GB.

By substituting PCM array 240 for a 2 GB area of an MLC array, and by utilizing a remaining 6 GB of NAND array 230, a logical address space for non-volatile memory device 200 may comprise 8 GB of storage. In an embodiment, a system memory space may be mapped onto a 2 GB SLC area comprising PCM array 240. A memory space of 6 GB may also be mapped onto three 2 GB areas comprising NAND array 230, in an embodiment. Memory space before adding PCM array 240 is 8 GB; however, after adding an SLC area mapped to PCM array 240 available memory space remains 8 GB, for an example embodiment. This may be advantageous for software compatibility since the size of the logical address space remains consistent between alternate memory configurations; however, overall memory system performance may nonetheless improve with the substitution.

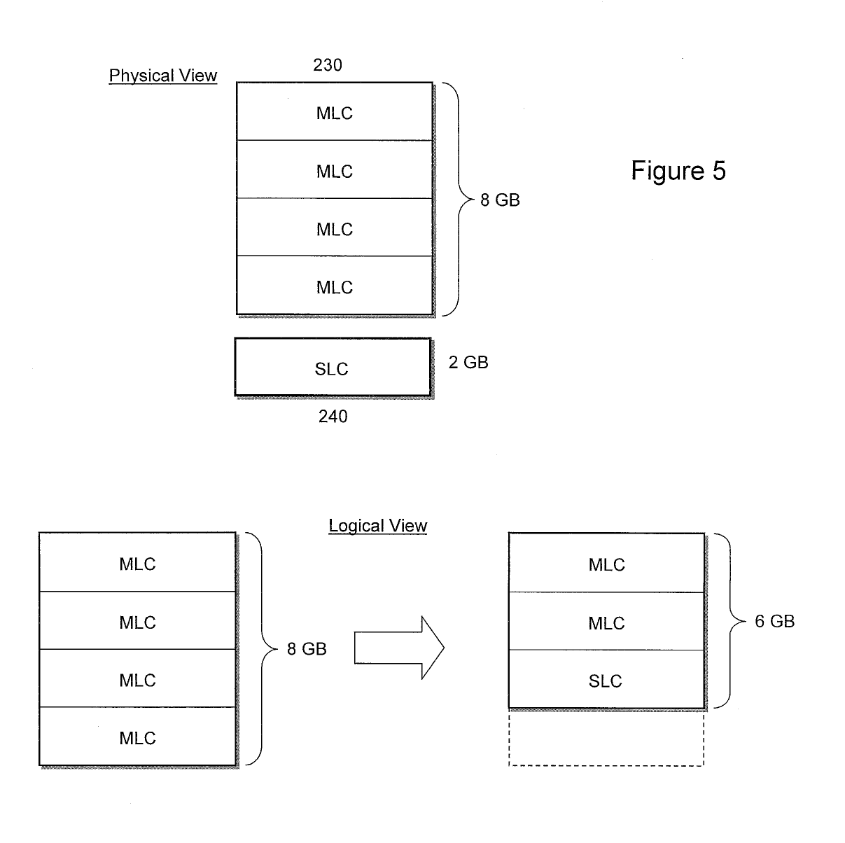

FIG. 5 is a block diagram depicting example logical and physical address spaces for another example embodiment. Memory 200 may again comprise NAND array 230 and PCM array 240. NAND array 230 may comprise 8 GBytes of storage area, as before. For example, NAND array 230 may be implemented as 4 GB of individual cells, where an individual cell may store two binary digital signals or bits of information as a state. Array 230 may be partitioned into four areas of 2 GB storage, as depicted in FIG. 5, although claimed subject matter is not limited in this respect. Therefore, again, an initial view of a logical address space for NAND array 230 may comprise an address space of 8 GB, which also represents its physical storage area.

Although a portion of an MLC array could be implemented as an SLC area, in an example embodiment, PCM array 240 may instead be utilized as an SLC array, rather than utilizing sections of NAND array 230. As depicted in FIG. 5, two MLC areas of NAND array 230 may make up another 4 GB of logical memory space. Thus, in an embodiment, 6 GB of memory space may be available.

A resulting 6 GB of logical memory space for the example of FIG. 5 is the same as seen above with the example of FIG. 3, although that example related to a managed flex system rather than a managed hybrid system. However, software generated for a managed flex system such as in FIG. 3 may be compatible with the example of FIG. 5 due to similarity of a resulting logical address space.

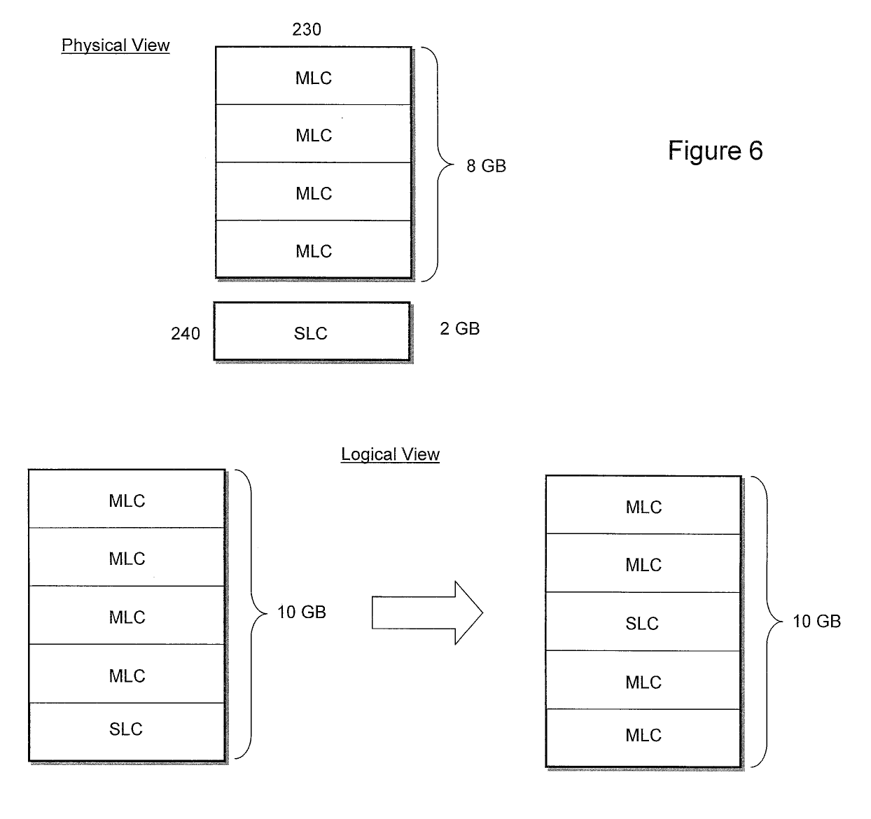

FIG. 6 is a block diagram depicting example logical and physical address spaces for yet another example embodiment. Memory 200, again, may comprise NAND array 230 and PCM array 240. For an example embodiment, NAND array 230 may comprise an array of multi-level-cells (MLC). Also in an embodiment, NAND array 230 may comprise 8 GBytes of storage area. NAND array 230 may be partitioned into four areas of 2 GB storage, as depicted in FIG. 6, although claimed subject matter is not limited in this respect. PCM array 240 may comprise 2 GB of storage area, in an embodiment. Therefore, initially, a view of a logical address space provides 10 GB, which represents a physical storage area of NAND array 230 and PCM array 240.

In an embodiment, a system memory space may be mapped onto a 2 GB SLC area comprising PCM array 240. A memory space of 8 GB may also be mapped onto four 2 GB areas comprising NAND array 230, in an embodiment. Combining a 2 GB system memory space and an 8 GB memory space may yield a logical address space of 10 GB. A logical address space before and after reconfiguration may therefore comprise 10 GB.

An example embodiment of a method for logical-to-physical address mapping for a non-volatile memory device may comprise mapping a logical address space to one or more non-volatile memory devices employing different memory technologies. For example, a system memory space may be mapped to one or more single-level-cell (SLC) areas of one or more non-volatile memory devices employing a first memory technology. Another or a second memory space may be mapped to one or more multi-level-cell (MLC) areas of one or more non-volatile memory devices employing another or second memory technology. For example, a first memory technology may comprise PCM technology and a second memory technology may comprise NAND memory technology. Of course, other memory technologies, such as flash memory, NOR technology, and/or resistive memory technology, may also be employed in other embodiments.

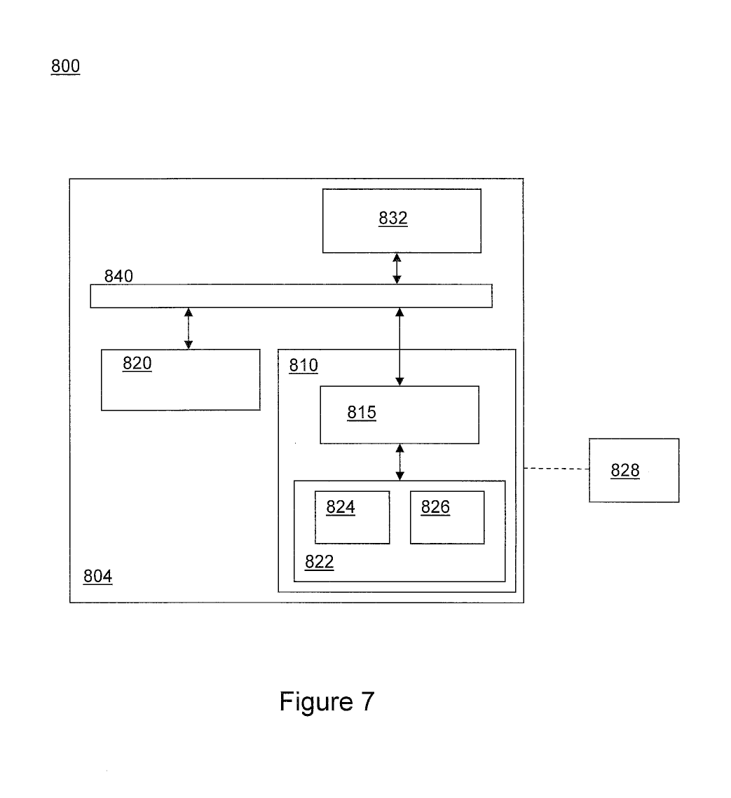

FIG. 7 is a schematic block diagram illustrating an example embodiment of a computing platform 800 including a memory device 810. Such a computing device may comprise one or more processors, for example, to execute an application and/or other code. For example, memory device 810 may comprise a non-volatile memory device, such as that depicted in FIG. 1. A computing device 804 may be representative of any device, appliance, or machine that may have a configuration to manage memory device 810. Memory device 810 may include a memory controller 815 and a memory 822. By way of example, but not limitation, computing device 804 may include: one or more computing devices and/or platforms, such as, e.g., a desktop computer, a laptop computer, a workstation, a server device, and/or the like; one or more personal computing, communication devices, and/or appliances, such as, e.g., a personal digital assistant, mobile communication device, nad/or the like; a computing system and/or associated service provider capability, such as, e.g., a database and/or data storage service provider/system; and/or any combination thereof.

It is recognized that all or part of the various devices shown in system 800, and the processes and methods as further described herein, may be implemented using and/or otherwise including hardware, firmware, software, and/or any combination thereof (other than software per se). Thus, by way of example but not limitation, computing device 804 may include at least one processing unit 820 operatively coupled to memory 822 through a bus 840 and a host or memory controller 815. Processing unit 820 is representative of one or more circuits having a configuration to perform at least a portion of a computing procedure or process. By way of example but not limitation, processing unit 820 may include one or more processors, controllers, microprocessors, microcontrollers, application specific integrated circuits, digital signal processors, programmable logic devices, field programmable gate arrays, the like, and/or any combination thereof. Processing unit 820 may include an operating system having a configuration to communicate with memory controller 815. Such an operating system may, for example, generate commands to be sent to memory controller 815 via bus 840. In one implementation, memory controller 815 may comprise an internal memory controller and/or an internal write state machine, wherein an external memory controller (not shown) may be external to memory device 810 and may act as an interface between the system processor and the memory itself, for example. Memory 822 is representative of any storage mechanism. Memory 822 may include, for example, a primary memory 824 and/or a secondary memory 826. Memory 822 may comprise a non-volatile memory array, for example. While illustrated in this example as being separate from processing unit 820, it should be understood that all or part of primary memory 824 may be provided within and/or otherwise co-located/coupled with processing unit 820.

Memory device 810 may include, for example, functional units similar to those described above in connection with memory device 200, wherein functional units are provided to perform logical-to-physical address mapping operations related to one or more types of non-volatile memory technologies in one or more arrays of non-volatile memory cells. For example, in an embodiment, a PCM cell array may serve as an SLC array and a NAND array may comprise an MLC array. However, claimed subject matter is not limited in scope in these respects. In an embodiment, memory device 810 may comprise a single integrated circuit die, although in other embodiments memory device 810 may comprise two or more separate integrated circuit die, for example.

Secondary memory 826 may include, for example, the same or similar type of memory as primary memory and/or one or more storage devices and/or systems, such as, for example, a disk drive, an optical disc drive, a tape drive, a solid state memory drive, etc. In certain implementations, secondary memory 826 may be operatively receptive of, and/or otherwise have a configuration to couple to, a computer-readable medium 828. Computer-readable medium 828 may include, for example, any medium that can carry and/or make accessible memory states, such as code and/or instructions for one or more of the devices in system 800.

Computing device 804 may include, for example, an input/output 832. Input/output 832 is representative of one or more devices and/or features that may have a configuration to accept and/or otherwise introduce human and/or machine inputs, and/or one or more devices and/or features that may have a configuration to deliver and/or otherwise provide for human and/or machine outputs. By way of example, but not limitation, input/output device 832 may include an operative configuration of a display, speaker, keyboard, mouse, trackball, touch screen, data port, etc.

Reference throughout this specification to “one embodiment” and/or “an embodiment” may mean that a particular feature, structure, and/or characteristic described in connection with a particular embodiment may be included in at least one embodiment of claimed subject matter. Thus, appearances of the phrase “in one embodiment” and/or “an embodiment” in various places throughout this specification are not necessarily intended to refer to the same embodiment or to any one particular embodiment described. Furthermore, it is to be understood that particular features, structures, and/or characteristics described may be combined in various ways in one or more embodiments. In general, of course, these and other issues may vary with the particular context of usage. Therefore, the particular context of the description and/or the usage of these terms may provide helpful guidance regarding inferences to be drawn for that context.

Likewise, the terms, “and/or”, “and,” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe some combination of features, structures and/or characteristics. Though, it should be noted that this is merely an illustrative example and claimed subject matter is not limited to this example.

Some portions of the detailed description included herein are presented in terms of algorithms and/or symbolic representations of operations on binary digital signals stored within a memory of a specific apparatus, computing device and/or platform. In the context of this particular specification, the term specific apparatus and/or the like includes a general purpose computing device once it is programmed to perform particular operations pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, quantities may take the form of electrical and/or magnetic signals and/or states capable of being stored, transferred, combined, compared and/or otherwise manipulated. It has proven convenient at times, principally for reasons of common usage, to refer to such signals and/or states as bits, data, values, elements, symbols, characters, terms, numbers, numerals, and/or the like. It should be understood, however, that all of these and/or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions and/or processes of a specific apparatus, such as a special purpose computer and/or computing device. In the context of this specification, therefore, a special purpose computer and/or computing device is capable of manipulating and/or transforming signals, typically represented as physical electronic and/or magnetic quantities within memories, registers, and/or other information storage devices, transmission devices, and/or display devices of the special purpose computer and/or computing device.

In some circumstances, operation of a memory device, such as a change in state from a binary one to a binary zero and/or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge and/or a release of stored charge. Likewise, in other memory devices, a change of state may comprise a physical change, such as transformation in magnetic orientation and/or transformation in molecular structure, such as from crystalline to amorphous or vice-versa. The foregoing is not intended to be an exhaustive list of all examples in which a change in state for a binary one to a binary zero and/or vice-versa in a memory device may comprise a transformation, such as a physical transformation. Rather, the foregoing is intended as illustrative examples.

A storage medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

In the preceding description, various aspects of claimed subject matter have been described. For purposes of explanation, systems and/or configurations were set forth to provide an understanding of claimed subject matter. However, claimed subject matter may be practiced without those specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. An apparatus, comprising:
one or more non-volatile memory arrays comprising one or more single-level-cell areas and one or more multi-level-cell areas, wherein the single-level-cell areas employ a different memory technology than the multi-level-cell areas; and
a controller to map a system memory space of a logical address space to the one or more single-level-cell areas and to map another memory space of the logical address space to the one or more multi-level-cell areas.

2. The apparatus of claim 1, wherein said one or more single-level-cells areas of the one or more non-volatile memory arrays comprise one or more single-level-cell arrays and wherein said one or more multi-level-cell areas of the one or more non-volatile memory arrays comprise one or more multi-level-cell arrays, the controller to map the system memory space to the one or more single-level-cell arrays; wherein the single-level-cell arrays employ a different memory technology than the multi-level-cell arrays.

3. The apparatus of claim 2, wherein the logical address space is configurable by the controller.

4. The apparatus of claim 3, wherein the logical address space is configurable by the controller to be compatible with software to manage a system of memory.

5. The apparatus of claim 4, wherein the logical address space is configurable by the controller to be compatible with software to manage a system of hybrid memory.

6. The apparatus of claim 4, wherein the logical address space is configurable by the controller to be compatible with software to manage a flex system of memory.

7. The apparatus of claim 1, wherein the single-level-cell area employs PCM technology and the multi-level-cell area employs NAND technology.

8. A method, comprising:
mapping a logical address space to one or more non-volatile memory devices employing different memory technologies wherein the system memory space is mapped to one or more single-level-cell areas of the one or more non-volatile memory devices employing a first memory technology and wherein the second memory space is mapped to one or more multi-level-cell areas of the one or more non-volatile memory devices employing a second memory technology.

9. The method of claim 8, wherein the single-level-cell areas and the multi-level-cell areas are on separate non-volatile memory devices respectively employing separate memory technology.

10. The method of claim 9, wherein mapping the logical address space to separate non-volatile memory devices is configurable.

11. The method of claim 9, wherein the first memory technology comprises PCM technology and the second memory technology comprises NAND technology.

12. The method of claim 9, wherein the logical address space is mapped to be compatible with system software for the multi-level cell areas.

13. The method of claim 12, wherein the logical address space is mapped to be compatible with managed flex system software for the multi-level cell areas.

14. The method of claim 8, wherein the first memory technology comprises PCM technology and the second memory technology comprises NAND technology.

15. A system, comprising:
a processor; and
a non-volatile memory device coupled to the processor, the non-volatile memory device to store one or more executable instructions to be fetched by the processor, the non-volatile memory device comprising
one or more non-volatile memory arrays comprising one or more single-level-cell areas and one or more multi-level-cell areas; wherein the single-level-cell areas employ a different memory technology than the multi-level-cell areas; and
a controller to map a system memory space of a logical address space to the one or more single-level-cell areas and to map another memory space of the logical address space to the one or more multi-level-cell areas.

16. The system of claim 14, the system memory space to store the one or more executable instructions to be fetched by the processor.

17. The system of claim 14, wherein the memory technology of one or more single-level-cell areas comprises PCM technology and the technology of the one or more multi-level-cell areas comprises flash memory technology.

18. The system of claim 14, wherein said one or more single-level-cells areas of the one or more non-volatile memory arrays comprise one or more single-level-cell PCM arrays and wherein said one or more multi-level-cell areas of the one or more non-volatile memory arrays comprise one or more multi-level-cell flash memory arrays, the controller to map the system memory space to the one or more single-level-cell non-volatile arrays.

19. The system of claim 17, wherein a total area of the logical memory space comprises a total area of the one or more multi-level-cell arrays, the controller to map the second memory space to one or more multi-level-cell areas of the one or more multi-level-cell arrays, wherein the one or more multi-level-cell areas comprise less than the total area of the one or more multi-level-cell non-volatile arrays.

20. The system of claim 17, wherein a total area of the logical memory space comprises less than a total area of the one or more multi-level-cell arrays, the controller to map the second memory space to one or more multi-level-cell areas of the one or more multi-level-cell arrays, wherein the one or more multi-level-cell areas comprise less than the total area of the one or more multi-level-cell arrays.

21. The system of claim 17, wherein the size of the logical memory space comprises the size of the one or more multi-level-cell arrays and the one or more single-level-cell arrays, the controller to map the another memory space to the one or more multi-level-cell arrays.
